(19) United States
(12) Patent Application Publication
(10) Pub. No.: US 2018/0319061 A1
(43) Pub. Date: Nov. 8, 2018

(54) HARD SHELL IN-MOLD CUP AND LABEL

(71) Applicant: DYNAMIC DRINKWARE, LLC, OSHKOSH, WI (US)

(72) Inventors: ROBERT TRAVIS, PLYMOUTH, WI (US); JEFF SLUSARSKI, OSHKOSH, WI (US)

(73) Assignee: DYNAMIC DRINKWARE, LLC, OSHKOSH, WI (US)

(21) Appl. No.: 15/584,969

(22) Filed: May 2, 2017

(51) Int. Cl. B29C 45/14; B32B 7/12; B32B 1/02; B32B 27/08; B32B 27/32; B32B 27/36; B29C 45/16; B65D 65/40

(52) U.S. Cl. CPC B29C 45/14688; B32B 7/12; B32B 1/02; B32B 27/08; B32B 27/32; B32B 27/36; B29K 2023/12; B29C 45/1679; B29C 45/1671; B29C 45/14311; B65D 65/40; B32B 2439/02; B32B 2451/00; B32B 27/365

(57) ABSTRACT

The claimed invention provides a method for molding a decorative cup with a hard exterior shell and a molded cup with a hard exterior shell such that the ink of the decoration and the adhesive are encapsulated between the molding material and the hard exterior shell.

### FIELD OF THE INVENTION

The claimed invention relates to the art of in mold decorating. More specifically, the claimed invention relates to a molded cup with a hard exterior shell and a method for molding a cup with a hard exterior shell.

### BACKGROUND OF THE INVENTION

Many decorated containers are not molded. Instead, the container is decorated using dry offset or pad printing processes. Those products that are molded use a laminated or coated label. These types of labels are susceptible to damage as will be further discussed below.

Typical in-mold cup labels are made with a coating applied over the ink to prevent the ink from escaping the surface. There are several disadvantages of such coatings. Typically, the coating process produces a film layer that is less than 0.001″. Such a thin layer is often inadequate to create a continuous film that is free from voids. Additionally, the coating layer is susceptible to scratches and abrasion from normal usage. Such voids, scratches and abrasions can create a pathway for contaminates to damage the image. These same pathways can allow for moisture to get under the coating and to further damage the coating layer and the image.

Lamination has also been used to seal the ink under the surface of the laminate. Typically, the laminate is a thin gauge layer of polypropylene. Lamination has been used because the laminated film expands and shrinks at a rate similar to the molded cup, which is critically important when the cups are exposed to multiple cycles of a dishwasher. Laminated films typically range from 0.0005″-0.003″ in the thickness. Although such films typically provide a continuous film seal, they are susceptible to scratches and abrasions. Additionally, the laminate typically has an edge that is close to the top and bottom edges of the cup and is thus susceptible to peeling. Deterioration of either a coating layer or a laminate layer can allow for ink migrations and will cause deterioration to the image and may allow ink and adhesive to be exposed to human contact.

Existing production methods are deficient for other reasons. For example, existing methods do not allow for photographic quality graphics. Additionally, existing production methods are not flexible, that is, they do not allow for personalization and customization of individual products.

A significant obstacle to using existing materials in the molding process is that polypropylene, a typically preferred molding material, shrinks significantly as it cools after the molding process. For example, shrinkage in a relatively thin-walled cup is typically 0.009-0.025 inches/inch. This level of shrinkage creates sheer stress between the label and the molded polypropylene material. Ideally, the in-mold label absorbs the shrinkage or the label itself shrinks as it cools. If the label does not either absorb the shrinkage of the polypropylene or shrink itself, the label could be damaged during the molding process. For this reason, typical IML labels are made with a polypropylene base layer and a coating to protect the inks. Use of this type of base layer molds relatively easily and without shear stress between the molded cup and the layer because the polypropylene label bonds well with the polypropylene molded material, which have similar shrink rates.

What is needed is a decorated in-mold product with a hard exterior shell that prevents ink migration and that maintains a high level of graphic image quality.

### SUMMARY OF THE INVENTION

The claimed invention teaches a method for producing a molded article with a rigid, digitally printed label. More specifically, the claimed invention is a method for molding a cup wherein the ink is encapsulated by a thin hard shell to prevent ink migration and to protect the integrity of the in-mold decoration. The claimed invention further provides for a digital printing process used to print the label. The claimed invention further provides for a label that thermally bonds to the injection molded article. The label itself is designed to protect the inks used during the injection molding process. The claimed invention further employs an adhesive that bonds to the digital print and the thermally protective layer. A specific aspect of the label, the adhesive and the thermal bond layer is that they are collectively designed to withstand the shear forces of the injection molded article. The claimed article provides a superior product in terms of aesthetics and durability, including through dishwashing cycles.

### BRIEF DESCRIPTION OF THE DRAWINGS

FIG. 1 is a cross-sectional schematic drawing of a prior art in mold label molded into a plastic cup wherein the in mold label has been coated.

FIG. 1A is an enlarged cross-sectional view of FIG. 1.

FIG. 2 is a cross-sectional schematic drawing of a prior art in mold label molded into a plastic cup wherein the in mold label has been laminated.

FIG. 2A is an enlarged cross-sectional view of FIG. 2.

FIG. 3 is a cross-sectional schematic drawing of the claimed invention showing a hard shell protected ink in mold label molded into a cup.

FIG. 3A is an enlarged cross-sectional view of FIG. 3.

FIG. 4 is a drawing comparing the shrinkage of a 16 ounce heavy wall cup with a protected ink label and a 16 ounce heavy wall cup with a standard in-mold label. Although both cups are molded with the same polypropylene resin in the same amount, the in-mold label cup shrinks considerably more than the protected ink cup.

FIG. 5 is a production schematic for a protected ink label.

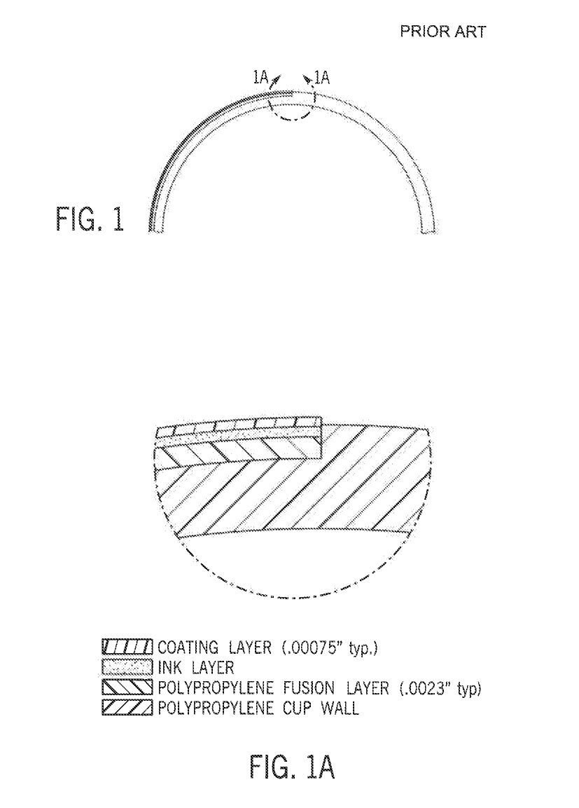

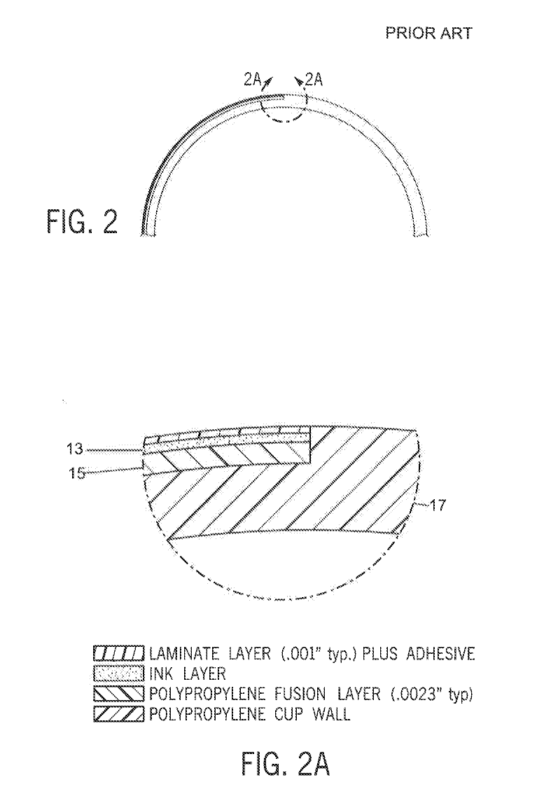

### DETAILED DESCRIPTION

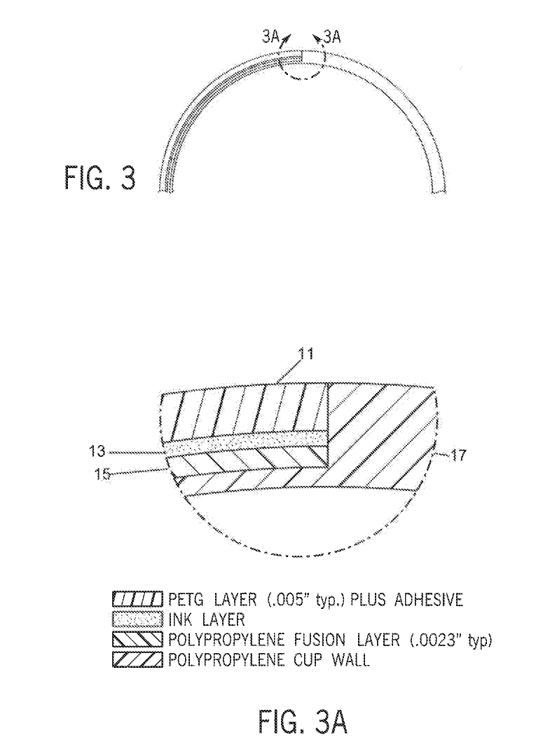

Now referring to the drawings in detail wherein like reference numerals refer to like elements throughout, FIGS. 3 and 3A show a cross-sectional schematic view of the claimed invention. As shown in more detail in FIG. 3A, hard shell material 11 comprises the outer section of the printed label. In one embodiment of the claimed invention, the hard surface layer 11 is printed with the label decoration resulting in an ink layer 13. A second embodiment provides for printing the thermally protective layer material.

Hard shell material 11 can be one of a number of possible materials including polycarbonate (“PC”) and polyethylene terephthalate (“PETG”). Primary considerations for hard shell 11 materials are price, heat softening and food safety. For these reasons, PETG is the currently preferred material for the hard shell 11. PETG is also preferable because it provides a very glossy appearance in comparison to other materials. PETG can also provide an alternative satin luster finish not currently available with other materials. Using PETG as an external protective layer protects the ink from degradation, making for longer lasting decoration, which is very important in the highly brand conscious souvenir cup industry. PETG is also BPA free, food safe and dishwasher safe.

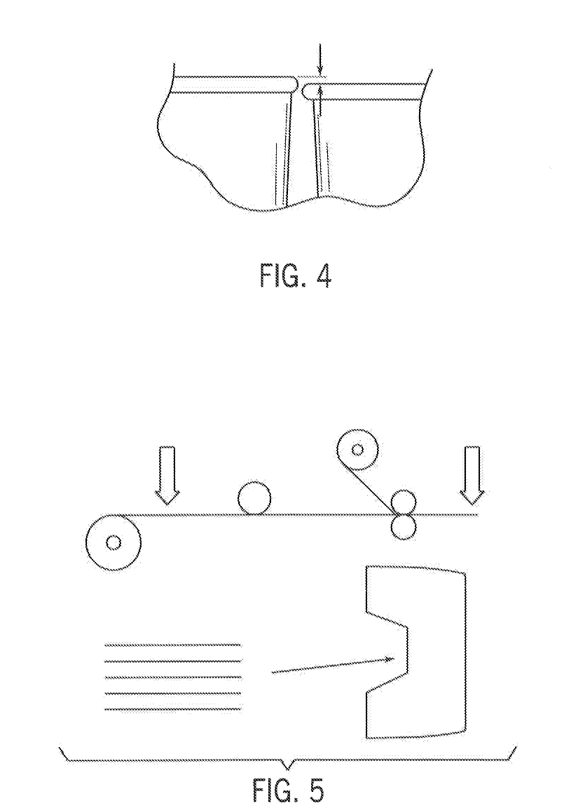

Referring to FIG. 4, which shows that standard IML label cups shrink significantly as the molten polypropylene cools and hardens. Conventional IML labels are printed on a polypropylene substrate, which shrinks with the molten polypropylene as the molded cup cools. Thus, shrinkage is not a significant issue with standard in mold label cups. However, shrinkage is a significant problem in the claimed protected ink cups. The reason that shrinkage is a problem is that polypropylene used to mold the cups has a higher shrink rate than PETG, the material selected for the protected ink label. The shrinkage of the polypropylene relative to the PETG label requires that the PETG label have sufficient strength and rigidity to withstand the force caused by the shrinkage of the polypropylene molding material.

Referring back to FIGS. 3 and 3A, a molded container of the claimed invention comprises a hard shell material 11. Hard shell exterior ranges in thickness from between 0.002 inches to 0.008 inches. Most preferably, hard shell exterior is approximately 0.005 inches. As shown, hard shell material 11 also includes adhesive layer. The hard shell material 11 protects the ink layer 13, essentially sealing the ink layer 13 away from the surface of the cup. Ink layer 13 is printed onto primed polypropylene fusion layer 15 according to methods known in the art. Fusion layer 15 is polypropylene such that it bonds well with the polypropylene cup wall 17 during the molding process. Fusion layer is between approximately 0.0015 inches and 0.0031 inches thick. Most preferably, fusion layer is approximately 0.0023 inches thick. Adhesive laminate layer or fusion layer 15 provides high peak strength but is also sufficiently flexible to withstand the shearing force created by the shrinkage of the polypropylene molding material relative to the hard shell 11 material as the molded article cools. Finally, the edge cutting profile of the protected ink label helps relieve shearing force created by the shrinkage of the polypropylene molding material relative to the hard shell 11 material.

It is critical that the ink layer withstands the molding process and that it withstands the shear forces created between the label and the cup when the molten plastic cools, hardens and shrinks relative to the label. For this reason the PETG is either subsurface printed or surface printed using a fusion layer. Either treatment allows the ink to absorb higher shear forces.

Alternatively, as shown in the process diagram in FIG. 5, the claimed invention provides a process for printing the image directly on the thermally protective layer in a continuous process. Once the image is printed, adhesive is applied to the image downstream of the printing process. Following application of the adhesive layer, the rigid protective layer is applied via a lamination process. Upon completion of the lamination process, labels are die cut to size and inserted into the molding cavity whereupon molten plastic is injected to form a plastic cup.

The claimed process provides a new and unique method for molding a souvenir cup using a rigid outer shell to protect the ink layer. The claimed process and cup provides a cup structure wherein both the ink and the adhesive are within the wall of the molded cup, thus reducing the potential for exposure to either the ink or the adhesive. The claimed structure is significantly less susceptible to lamination peel than polypropylene laminated parts and ink migration. Additionally, the structure of the claimed invention is significantly less susceptible to deterioration from everyday use, including dishwasher cleaning and abrasion.

The present invention has been described in terms of embodiments. While preferred embodiments of the present invention have been described using specific terms, such description is for illustrative purposes, and it is to be understood that changes and variations may be made without departing from the spirit or scope of the invention.

What is claimed is:

1. A decorated injection molded container comprising:
a polypropylene fusion layer;
an image applied in ink to the polypropylene fusion layer;
an adhesive layer applied to the image bearing polypropylene fusion layer;
a clear rigid protective layer applied over the adhesive layer;
an injection molded polypropylene layer, the injection molded polypropylene layer molding integrally with the image bearing fusion layer such that the adhesive layer and the ink of the image are encapsulated between the injection molded polypropylene layer and the rigid protective layer.

2. The decorated injection molded container of claim 1 wherein the clear rigid protective layer is polycarbonate.

3. The decorated injection molded container of claim 1 wherein the clear rigid protective layer is polyethylene terephthalate.

4. The decorated injection molded container of claim 1 wherein the clear rigid protective layer is between about 0.001 and 0.006 inches thick.

5. The decorated injection molded container of claim 1 wherein the polypropylene fusion layer is between about 0.0020 and 0.0026 inches thick.

6. A decorated injection molded container comprising:
a clear rigid protective layer;
an image applied to the clear protective layer;
a polypropylene fusion layer;
an adhesive layer applied to the image bearing polypropylene fusion layer, the adhesive layer operable to bond the polypropylene fusion layer to the image applied to the protective layer;
an injection molded polypropylene layer, the injection molded polypropylene layer molding integrally with the fusion layer such that the adhesive layer and the ink of the image are encapsulated between the injection molded polypropylene layer and the rigid protective layer.

7. The decorated injection molded container of claim 6 wherein the clear rigid protective layer is polycarbonate.

8. The decorated injection molded container of claim 6 wherein the clear rigid protective layer is polyethylene terephthalate.

9. The decorated injection molded container of claim 6 wherein the clear rigid protective layer is between about 0.001 and 0.006 inches thick.

10. The decorated injection molded container of claim 6 wherein the polypropylene fusion layer is between about 0.0020 and 0.0026 inches thick.
